(19) United States
(12) Patent Application Publication
(10) Pub. No.: US 2014/0293998 A1
(43) Pub. Date: Oct. 2, 2014

(54) BACKPLANE APPARATUS AND SWITCHING SYSTEM USING THE SAME

(71) Applicant: Electronics and Telecommunications Research Institute, Daejeon (KR)

(72) Inventors: Taesik CHEUNG, Daejeon (KR); Bheom Soon JOO, Daejeon (KR)

(73) Assignee: Electronics and Telecommunications Research Institute, Daejeon (KR)

(21) Appl. No.: 14/091,891

(22) Filed: Nov. 27, 2013

(30) Foreign Application Priority Data
Mar. 27, 2013 (KR) 10-2013-0033052

(51) Int. Cl. H04L 12/933

(52) U.S. Cl. CPC H04L 49/15
USPC 370/364

(57) ABSTRACT

In a switching system using an N+1 switch redundancy method, a backplane connects a plurality of switch cards that are mounted in a half-slot of an upper end portion and a lower end portion of the center of a chassis and a plurality of line cards that are mounted in the half-slot of the upper end portion and the lower end portion of the chassis at both sides of the plurality of switch cards. In this case, in each line card and each switch card, a line card and a switch card of the same position are connected in the upper end portion or the lower end portion of the chassis using some connector groups, and a line card and a switch card that are disposed at the upper end portion or the lower end portion of the chassis are crossed and connected using the remaining connector groups.

### CROSS-REFERENCE TO RELATED APPLICATION

This application claims priority to and the benefit of Korean Patent Application No. 10-2013-0033052 filed in the Korean Intellectual Property Office on Mar. 27, 2013, the entire contents of which are incorporated herein by reference.

### BACKGROUND OF THE INVENTION

(a) Field of the Invention

The present invention relates to a backplane apparatus and a switching system using the same. More particularly, the present invention relates to a backplane connection in a switching system that forms a switch card in redundancy.

(b) Description of the Related Art

A conventional switching system uses a 1+1 switch redundancy method of mounting two switch cards and maintaining switching performance with the remaining one switch card, even if one switch card has failed.

The 1+1 switch redundancy method is a method of securing a preliminary switching capacity of 100%, and the method designs a switch fabric interface of a line card to be the double an actually necessary bandwidth, or reduces and uses processing capacity of a line card in order to provide 1+1 switch redundancy in a given bandwidth.

The 1+1 switch redundancy method has a simple system structure and enables an easy signal routing trace in a backplane, as shown in FIG. 1, and is thus widely used in a system that provides switching capacity of a several hundred Gb/s range. However, because this method requires a preliminary switching capacity of 100%, the method has a problem that much preliminary capacity is wasted in a large capacity switching system of a several Tb/s range.

In FIG. 1, (a) illustrates a system structure that is formed with processor cards PC, line cards LC, and switch card SCs, and (b) illustrates a logical connection between line cards and switch cards in a backplane.

Because the N+1 switch redundancy method enhances efficiency of a switching capacity utilization while securing reliability of a switching system, the N+1 switch redundancy method is generally used in a large capacity switching system. In the method, as N+1 switch cards are mounted, even if one switch card has failed, 100% switching performance is maintained. For this purpose, a line card is uniformly connected to N+1 switch cards, and a bandwidth of a switch fabric interface between one line card and one switch card, becomes 1/N of an entire switching capacity. For example, in 3+1 switch redundancy, a bandwidth of a switch fabric interface that is required in the line card becomes (100%/3)×4=133% and thus it is only required to secure a preliminary capacity of 33%.

A mid-plane structure may be applied to a switching system using the N+1 switch redundancy method. This structure disposes line cards LC at one side of the system and disposes switch cards SC perpendicular to the line card LC at the other side of the system, as shown in (a) of FIG. 2, and the mid-plane mounts an orthogonal connector at both sides and connects the line card LC and the switch card SC back-to-back, as shown in (b) and (c) of FIG. 2.

In the mid-plane structure, a plurality of line cards LC and switch cards SC are directly connected by an orthogonal connector on a mid-plane, and thus the mid-plane structure has a merit that complicated traces is unnecessary in a backplane. However, because this structure should generate air flow of different directions for cooling of the line card LC and the switch card SC, a switching system structure becomes complicated, and at a rear side, space for mounting and removing the switch card SC is additionally necessary and thus a limitation exists in installing the mid-plane structure.

In terms of simplicity of a system structure and flexibility of application, it is advantageous that a switching system of the N+1 switch redundancy method is formed in a backplane structure, as shown in FIG. 3, but the switching system has the following problems.

First, the number of slots that can mount a line card LC decreases. In general, in order to mount the switching system in a standard rack of 19 inches or 23 inches, a width of the system is limited and thus the entire slot number is also limited. Therefore, when a plurality of slots are used for mounting the switch cards SC, the number of line cards that may be mounted in the system decreases. Because this means that capacity per line card LC largely increases in a large capacity system, granularity of a system capacity increases and thus flexibility of application is deteriorated.

Second, it is difficult to design a backplane that connects the line card LC and a plurality of switch cards SC. In general, a switch fabric interface (fabric I/F) that connects the line card LC and the switch card SC uses a differential high speed signal of several Gb/s or more. In order to maintain transmission quality of a high speed signal, impedance of a transmitting/receiving driver and impedance of trace should correspond, and a discontinuous point of impedance on a transmission line should be minimized. For this purpose, in routing traces in a backplane, in order to prevent a stub by via from occurring, it is a principle to layout one signal trace in a single layer. When connecting a plurality of line cards LC and a plurality of switch cards SC, signal traces are frequently crossed and thus the number of stacked layers necessary for layout increases.

As can be seen in (a) and (b) of FIG. 3, the number of stacked layers necessary for a 3+1 switch redundancy structure may be increased to two times of that of a 1+1 switch redundancy structure according to a conventional system structure and routing method.

### SUMMARY OF THE INVENTION

The present invention has been made in an effort to provide a backplane apparatus and a switching system using the same having advantages of minimizing a stacking number necessary for a redundancy structure while easily embodying a large capacity switching system using an N+1 switch redundancy method.

An exemplary embodiment of the present invention provides a switching system using an N+1 switch redundancy method. The switching system includes a chassis, a plurality of switch cards, a plurality of line cards, and a backplane. The chassis includes a plurality of half-slots and is formed with an upper end portion and a lower end portion. The plurality of switch cards are divided and mounted in a half-slot of an upper end portion and a lower end portion of the center of the chassis, and each form a connector group. The plurality of line cards are divided and mounted at a half-slot of the upper end portion and the lower end portion of the chassis at both sides of the plurality of switch cards, and each form a connector group. The backplane connects a line card and a switch card of the same position in the upper end portion or the lower end portion of the chassis using a first connector group at each line card and each switch card, and crosses and connects a line card and a switch card of different positions in the upper end portion or the lower end portion of the chassis using a second connector group.

The backplane may not overlap a trace for connecting a line card and a switch card of the same position and a trace for crossing and connecting a line card and a switch card of different positions.

The backplane may determine a connection within the first connector group and the second connector group according to a trace length.

The first connector group of the each line card may be positioned at the top of the each line card, and the second connector group of the each line card may be positioned at the bottom of the each line card.

The switching system may further include a plurality of processor cards that are divided and mounted in a half-slot of the upper end portion and the lower end portion of the chassis.

Each line card may include a third connector group for connecting to a corresponding processor card, and the third connector group of the each line card may be positioned at the center of the each line card that is separated from each of the first and second connector groups.

Another embodiment of the present invention provides a backplane apparatus. The backplane apparatus includes a chassis, a plurality of switch cards, and a plurality of line cards. The chassis includes a plurality of half-slots and is formed with an upper end portion and a lower end portion. The plurality of switch cards are divided and disposed at a half-slot of the upper end portion and the lower end portion of the chassis. The plurality of line cards are divided and disposed at the half-slot of the upper end portion and the lower end portion of the chassis at both sides of the plurality of switch cards. The plurality of line cards determines connection to the plurality of switch cards according to a disposition position of the upper end portion and the lower end portion of the chassis.

The plurality of line cards may include a plurality of first and second connectors, a plurality of first connectors of a line card that is disposed at the upper end portion of the chassis may each be used for connecting to a switch card that is disposed at the upper end portion of the chassis, and a plurality of second connectors of a line card that is disposed at the upper end portion of the chassis may each be used for connecting to a switch card that is disposed at the lower end portion of the chassis. A plurality of first connectors of a line card that is disposed at the lower end portion of the chassis may each be used for connecting to a switch card that is disposed at the upper end portion of the chassis, and a plurality of second connectors of a line card that is disposed at the lower end portion of the chassis may each be used for connecting to a switch card that is disposed at the lower end portion of the chassis.

The plurality of first and second connectors may each be separated from the center at a position to be disposed at an upper portion and a lower portion of the center of a corresponding line card.

The backplane apparatus may further include a plurality of processor cards that are disposed at one side of the chassis and that are divided and mounted in a half-slot of the upper end portion and the lower end portion of the chassis.

The plurality of line cards may each further include a third connector that is used for connecting to a corresponding processor card, and the third connector may be disposed at a central position of a corresponding line card.

The plurality of switch cards may each include a fourth connector that is used for connecting to a corresponding processor card, and the fourth connector may be disposed at the bottom position of a corresponding switch card.

### BRIEF DESCRIPTION OF THE DRAWINGS

FIG. 1 is a diagram illustrating an example of a backplane structure and layout in a system using a conventional 1+1 switch redundancy method.

FIG. 2 is a diagram illustrating an example of a mid-plane structure in a system using a conventional N+1 switch redundancy method.

FIG. 3 is a diagram illustrating an example of a backplane structure and layout in a system using a conventional N+1 switch redundancy method.

FIG. 4 is a diagram illustrating a backplane structure of a switching system according to an exemplary embodiment of the present invention.

FIGS. 5 and 6 are each a diagram illustrating layout in a backplane of FIG. 4.

FIG. 7 is a diagram illustrating a backplane connection for a 3+1 switch redundancy structure according to an exemplary embodiment of the present invention.

FIG. 8 is a diagram illustrating an example of a physical interconnection between a line card and a switch card according to an exemplary embodiment of the present invention.

FIGS. 9 and 10 are diagrams illustrating areas A and B of FIG. 7, respectively, in order to describe a trace routing crossing an upper end portion and a lower end portion.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification and claims, unless explicitly described to the contrary, the word “comprise” and variations such as “comprises” or “comprising” will be understood to imply the inclusion of stated elements but not the exclusion of any other elements.

Hereinafter, a backplane apparatus and a switching system using the same according to an exemplary embodiment of the present invention will be described in detail with reference to the drawings.

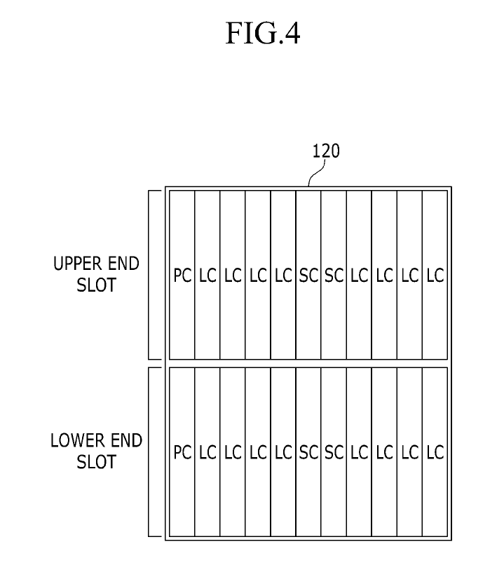

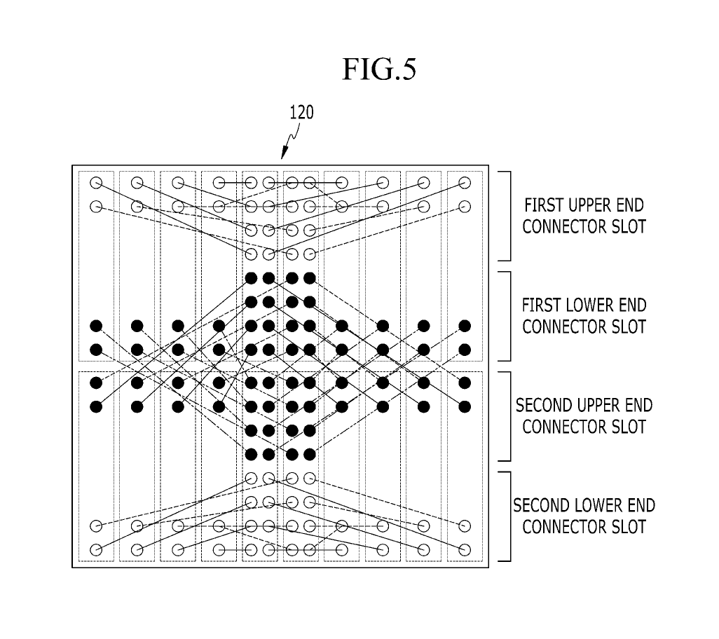

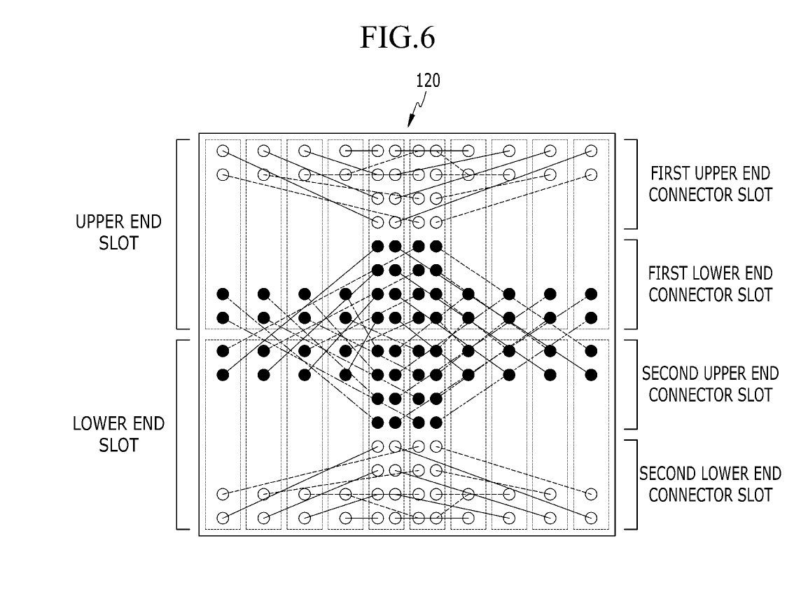

FIG. 4 is a diagram illustrating a backplane structure of a switching system according to an exemplary embodiment of the present invention, and FIGS. 5 and 6 each are diagrams illustrating a layout in a backplane of FIG. 4. Hereinafter, for convenience of description, a switching system using a 3+1 switch redundancy method in which N=3 is exemplified.

Referring to FIGS. 4 to 6, the switching system includes a chassis (not shown), a plurality of line cards (LC), a plurality of switch cards (SC), a plurality of processor cards (PC), and a backplane 120.

The chassis includes a plurality of half-slots and is formed with an upper end portion and a lower end portion. In the switching system using a 3+1 switch redundancy method, the chassis is formed with half-slots for two processor cards, half-slots for 4 switch cards, and half-slots for 16 line cards, and includes a total of 22 half-slots.

The plurality of switch cards SC are divided and disposed at an upper end slot and a lower end slot of the center of the chassis, and the plurality of line cards LC are divided and disposed at an upper end slot and a lower end slot at both sides about the plurality of switch cards SC.

The plurality of processor cards PC are divided and disposed at an upper end slot and a lower end slot of the chassis and are positioned at one side of the chassis. An exemplary embodiment of the present invention relates to a switch fabric connection between the line card LC and the switch card SC, and the processor card PC may be positioned at a random half-slot of the chassis.

The backplane 120 connects the plurality of switch cards SC and the plurality of line cards LC, as shown in FIGS. 5 and 6.

In the switching system using a 3+1 switch redundancy method, the number of switch cards SC is 4 and the number of line cards LC is 16. The 4 switch cards SC are disposed at two intermediate upper end slots and two lower end slots, i.e., a total of 4 half-slots of a system chassis, and 16 line cards LC are disposed at every 4 slots, i.e., a total of 16 slots at both sides of the switch card SC. Two processor cards PC are respectively disposed at an upper end slot and a lower end slot.

Referring to FIG. 5, in the backplane 120, the line card slot and the switch card slot have a connector group including 4 connectors and 16 connectors, respectively. Connector groups of a line card slot and a switch card slot that are positioned at an upper slot of the chassis are divided into a first upper end connector group and a first lower end connector group, respectively, and connector groups of a line card slot and a switch card slot that are positioned at a lower end slot of the chassis are divided into a second upper end connector group and a second lower end connector group, respectively.

In the line card LC and the switch card SC, a half connector group (represented by an open circle symbol) is used for connecting the line card LC and the switch card SC that are disposed at the same position, i.e., a horizontal position of the upper end portion or the lower end portion of the chassis, and in the line card LC and the switch card SC, the remaining half connector group (represented by a closed circle symbol) is used for crossing and connecting the line card LC and the switch card SC that are disposed at different positions, i.e., a vertical position of the upper end portion or the lower end portion of the chassis. For example, a first upper end connector group is used for connecting a line card LC and a switch card SC that are disposed at an upper end slot of the chassis, and a second lower end connector group is used for connecting a line card LC and a switch card SC that are disposed at a lower end slot of the chassis. The first lower end connector group and the second upper end connector group are used for crossing and connecting a line card LC and a switch card SC that are positioned at the upper end slot and the lower end slot of the chassis.

A connection within a connector group may be variously formed for optimization of routed trace length, as shown in FIG. 6.

However, trace routing within a horizontally connected connector group and trace routing within a vertically crossed and connected connector group should not be overlapped. For this purpose, in a switching system, the backplane 120 may route traces to change order of line cards that are connected to the switch cards SC according to a position at which line cards LC are mounted in an upper end portion and a lower end portion.

For example, a first upper end connector group of the line card LC that is mounted in an upper end slot is connected to switch cards SC that are mounted in an upper end slot, and a first lower end connector group of the line card LC is connected to switch cards SC that are mounted in a lower end slot. However, a second upper end connector group of a line card LC that is mounted in the lower end slot is connected to switch cards SC that are mounted in the upper end slot, and a second lower end connector group of a line card LC that is mounted in the lower end slot is connected to switch cards SC that are mounted in the lower end slot.

Because operation between a switch fabric interface chip and a switch fabric chip used in the line card LC and the switch card SC is independently performed, it is unnecessary for a connection between the two to be the same in all line cards, and each slot of the line card may have different switch fabric interface mapping information for setting and management of only a switch fabric interface.

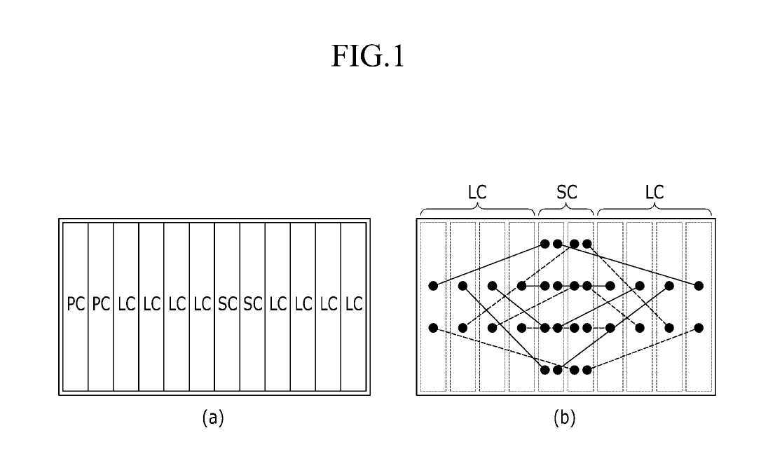

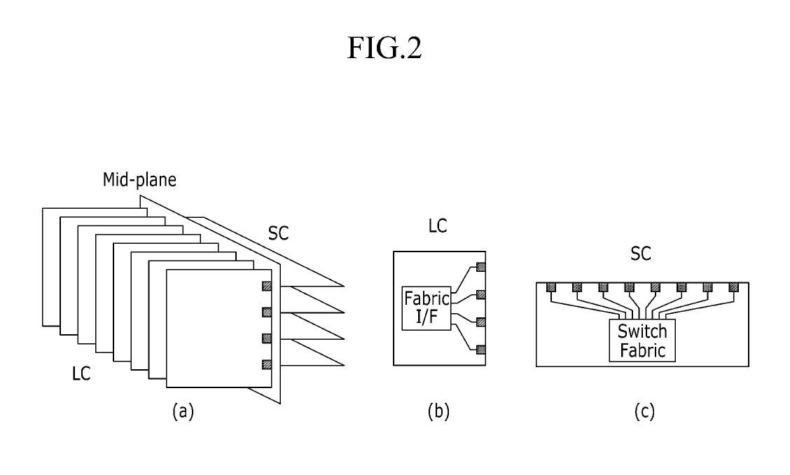

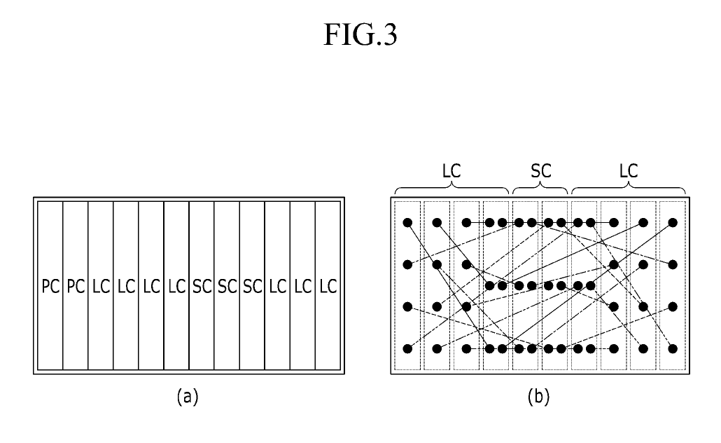

In FIG. 5, a connection of a line card LC and a switch card SC that are equally disposed in an upper end portion or a lower end portion has the same complexity as that of backplane layout when forming a 1+1 switch redundancy structure of FIG. 1. Further, because a crossing connection of a line card LC/switch card SC of an upper end slot and a switch card SC/line card LC of a lower end slot is not overlapped with other traces, the necessary stacking number in a connection method of the backplane 120 according to an exemplary embodiment of the present invention becomes the necessary stacking number in a conventional 1+1 switch redundancy structure or the necessary stacking number in a crossing connection of an upper end portion/lower end portion.

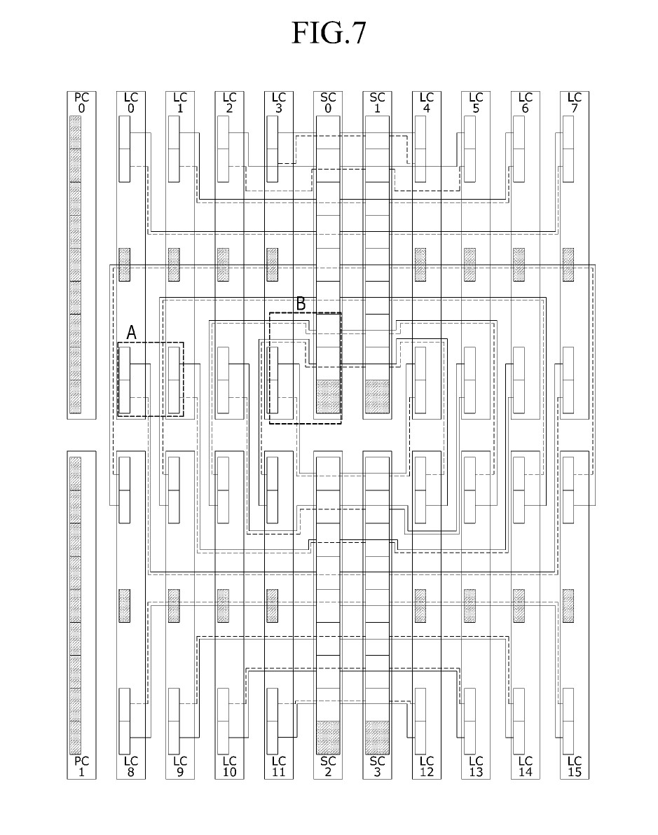

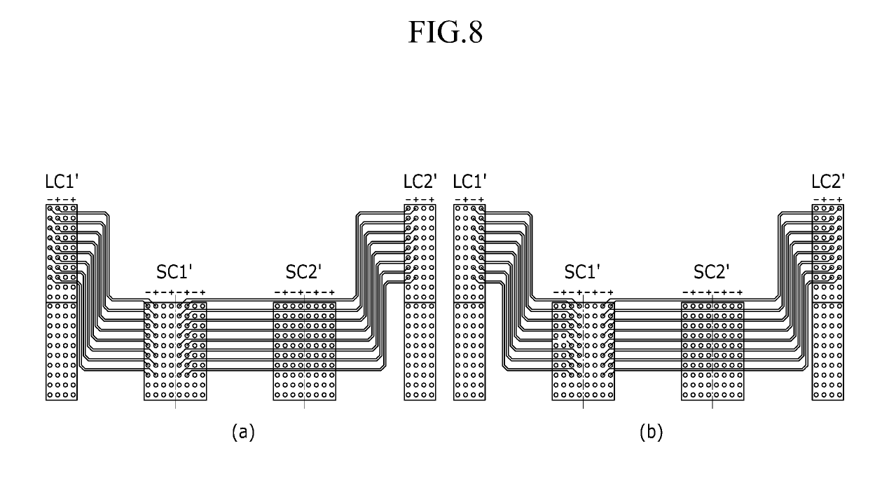

FIG. 7 is a diagram illustrating a backplane connection for a 3+1 switch redundancy structure according to an exemplary embodiment of the present invention, and FIG. 8 is a diagram illustrating an example of a physical interconnection between a line card and a switch card according to an exemplary embodiment of the present invention.

As described above, a switching system using a 3+1 switch redundancy method includes 4 switch cards SC0-SC3 and 16 line cards LC0-LC15.

In the switching system, the order of the 16 line cards LC0-LC15 that are connected to the switch cards SC0-SC3 may be changed according to a mounted position in an upper end slot and a lower end slot, and the order of the line cards LC0-LC15 that are equally mounted in the upper end slot or the lower end slot and that are connected to the switch cards SC0-SC3 for optimization of routed trace length may also be changed.

Referring to FIG. 7, a connector group of the line card LC0 that is mounted in the upper end slot is connected in order of the switch cards SC0, SC1, SC2, and SC3 from the top, and a connector group of the line card LC8 that is mounted in the lower end slot is connected in order of the switch cards SC1, SC0, SC3, and SC2 from the top.

A switch card generally uses a connector having an integration degree at least two times larger than that of a line card. For example, the switch card and the line card may use a differential connector having an 8 column pinhole and a 4 column pinhole, respectively.

Referring to FIG. 8, in a physical connection between line cards LC1′ and LC2′ and switch cards SC1′ and SC2′, a half left pinhole column of a connector at the switch card SC1′ is connected to the line card LC1′ that is disposed at the left side, and the remaining half right pinhole column of the switch card SC1′ is connected to the line card LC2′ that is disposed at the right side, as shown in (a) and (b) of FIG. 8, and thus the stacking number necessary for connecting one switch card SC1′ to a plurality of line cards becomes 2 and the stacking number necessary for tracing both switch cards becomes 4.

Similarly, the switch card SC2′ may also be connected to a plurality of line cards.

In a backplane connection of FIG. 7, a connection between the line cards LC0-LC7 and the switch cards SC0 and SC1 and between the line cards LC8-LC15 and the switch cards SC2 and SC3 is the same as that of a conventional 1+1 switch redundancy structure and thus the necessary stacking number becomes 4. Further, a connection between the line cards LC0-LC7 and the switch cards SC2 and SC3 and between the line cards LC8-LC15 and switch cards SC0 and SC1 disposes a connector so that a signal is not crossed or overlapped like a 1+1 switch redundancy structure, and thus the same stacking number as that necessary when forming the 1+1 switch redundancy structure becomes 4. Therefore, in a backplane connection according to an exemplary embodiment of the present invention, the necessary stacking number also becomes 4. For this purpose, the line cards LC0-LC7 and the line cards LC8-LC15 dispose a connector group (represented with a grey block) for connecting to processor cards PC1 and PC2, respectively, at an appropriate position of the center, and switch cards SC0-SC3 each dispose a connector group (represented with a white block) for connecting to a processor card at the bottom. Further, by disposing a connector group (represented with a white block) for connecting to the switch cards SC0-SC3 in the line cards LC0-LC7 by a half at the top and the bottom, respectively, in order to cross and connect the upper end portion and the lower end portion, a space in which signal trace can bypass the connector is provided.

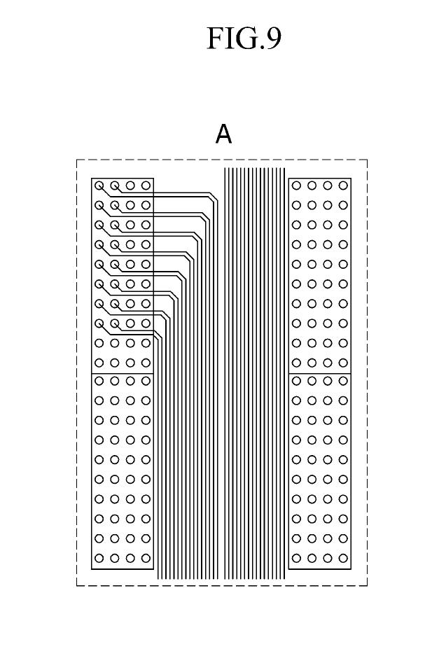

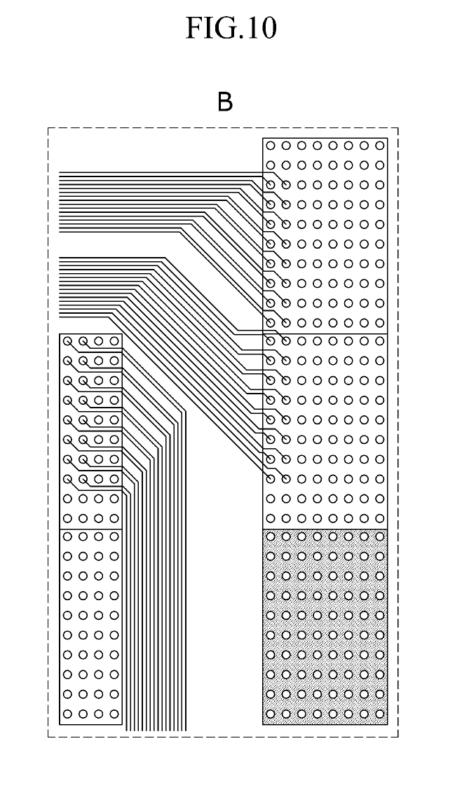

FIGS. 9 and 10 are diagrams illustrating areas A and B of FIG. 7, respectively, in order to describe signal trace crossing an upper end portion and a lower end portion.

As shown in FIGS. 9 and 10, for backplane layout according to an exemplary embodiment of the present invention, a gap between slots should be widened, compared with a gap between slots in a common 1+1 switch redundancy structure. For example, in a line card that provides a capacity of 200 Gb/s per slot, when using a switch fabric interface with a high speed signal of a 10 Gb/s level, it is necessary to connect one switch card and 8 signals. That is, even if only 3 switch cards of 4 switch cards operate, a bandwidth of 240 Gb/s (=10 Gb/s×8×3) may be provided.

A high speed signal of a 10 Gb/s level should use a differential signal, and in order to reduce signal attenuation by a skin effect, a pattern width of a signal should become 8 mil or more. When it is assumed that a gap between differential signals is 1.5 W (1.5 times of the width of the signal trace) and a gap between differential signal pairs is 3 W (3 times of the width of the signal trace), space necessary for routing 8 differential signal traces becomes 1 cm. Therefore, as shown in FIG. 9, when an upper end portion and a lower end portion are crossed and connected, in order for traces not to overlap two groups of 8 differential signal traces in a single layer, a gap between adjacent connectors should become 2 cm or more. In general, when a differential connector of a 4 column pinhole in which a gap between pinholes is a 1.5 mm pitch is used, a width of the connector is 1 cm or less and thus if a pitch between line cards is 3 cm or more, a backplane can be designed with the minimum stacking number. This is a value that may be provided in a system chassis that may be mounted in a 19 inch rack.

According to an exemplary embodiment of the present invention, by mounting both a line card and a switch card in a chassis of a half-slot structure and by connecting the line card and the switch card through a backplane, in a large capacity switching system, an efficient N+1 switch redundancy structure and a necessary slot number of the line card can be secured. Thereby, a system according to an exemplary embodiment of the present invention can reduce preliminary capacity that should be secured per unit line card for redundancy, simplify an air flow structure can be simplified compared with a system of a mid-plane structure, and eliminate restriction when installing the system. Further, because a backplane of a system that is formed with a plurality of line cards and plurality of switch cards that is formed by N+1 redundancy can be produced with the same stacking number as that of a backplane of a system using conventional 1+1 switch redundancy, a manufacture cost of a large capacity system can be lowered.

An exemplary embodiment of the present invention may not be only embodied through the above-described apparatus and/or method, but may also be embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A switching system using an N+1 switch redundancy method, comprising:
a chassis that comprises a plurality of half-slots and that is formed with an upper end portion and a lower end portion;
a plurality of switch cards that are divided and mounted in a half-slot of the upper end portion and the lower end portion of the center of the chassis and that each form a connector group;
a plurality of line cards that are divided and mounted at the half-slot of the upper end portion and the lower end portion of the chassis at both sides of the plurality of switch cards and that each form a connector group; and
a backplane that connects a line card and a switch card of the same position in the upper end portion or the lower end portion of the chassis using a first connector group at each line card and each switch card and that crosses and connects a line card and a switch card of different positions in the upper end portion or the lower end portion of the chassis using a second connector group.

2. The switching system of claim 1, wherein the backplane does not overlap a routed trace for connecting a line card and a switch card of the same position and a routed trace for crossing and connecting a line card and a switch card of different positions.

3. The switching system of claim 1, wherein the backplane determines a connection within the first connector group and the second connector group according to a routed trace length.

4. The switching system of claim 1, wherein the first connector group of the each line card is positioned at the top of the each line card, and the second connector group of the each line card is positioned at the bottom of the each line card.

5. The switching system of claim 4, further comprising a plurality of processor cards that are divided and mounted in a half-slot of the upper end portion and the lower end portion of the chassis.

6. The switching system of claim 5, wherein the each line card comprises a third connector group for connecting to a corresponding processor card, and
the third connector group of the each line card is positioned at the center of the each line card that is separated from each of the first and second connector groups.

7. A backplane apparatus, comprising:
a chassis that comprises a plurality of half-slots and that is formed with an upper end portion and a lower end portion;
a plurality of switch cards that are divided and disposed at a half-slot of the upper end portion and the lower end portion of the chassis; and
a plurality of line cards that are divided and disposed at the half-slot of the upper end portion and the lower end portion of the chassis at both sides of the plurality of switch cards,
wherein the plurality of line cards determine connection to the plurality of switch cards according to a disposition position of the upper end portion and the lower end portion of the chassis.

8. The backplane apparatus of claim 7, wherein the plurality of line cards comprise a plurality of first and second connectors,
a plurality of first connectors of a line card that is disposed at the upper end portion of the chassis are each used for connecting to a switch card that is disposed at the upper end portion of the chassis, and a plurality of second connectors of a line card that is disposed at the upper end portion of the chassis are each used for connecting to a switch card that is disposed at the lower end portion of the chassis, and
a plurality of first connectors of a line card that is disposed at the lower end portion of the chassis are each used for connecting to a switch card that is disposed at the upper end portion of the chassis, and a plurality of second connectors of a line card that is disposed at the lower end portion of the chassis are each used for connecting to a switch card that is disposed at the lower end portion of the chassis.

9. The backplane apparatus of claim 8, wherein the plurality of first and second connectors each are separated from the center at a position to be disposed at an upper portion and a lower portion of the center of a corresponding line card.

10. The backplane apparatus of claim 9, further comprising a plurality of processor cards that are disposed at one side of the chassis and that are divided and mounted in a half-slot of the upper end portion and the lower end portion of the chassis.

11. The backplane apparatus of claim 10, wherein the plurality of line cards each further comprise a third connector that is used for connecting to a corresponding processor card, and
the third connector is disposed at a central position of a corresponding line card.

12. The backplane apparatus of claim 10, wherein the plurality of switch cards each comprise a fourth connector that is used for connecting to a corresponding processor card, and
the fourth connector is disposed at the bottom position of a corresponding switch card.

13. The backplane apparatus of claim 8, wherein the plurality of switch cards comprise a plurality of third connectors for connection to the plurality of line cards, respectively, and
a half left side column of a third connector of each switch card is used for connecting to a line card that is disposed at the left side of a corresponding switch card, and a half right side column of a third connector of the each switch card is used for connecting to a line card that is disposed at the right side of a corresponding switch card.
